(19) United States
(12) Patent Application Publication
(10) Pub. No.: US 2022/0128174 A1
(43) Pub. Date: Apr. 28, 2022

(54) CLAMP

(71) Applicant: AIRBUS CANADA LIMITED PARTNERSHIP, Mirabel (CA)

(72) Inventor: Mohsen JALALI, MIRABEL (CA)

(21) Appl. No.: 17/506,765

(22) Filed: Oct. 21, 2021

(30) Foreign Application Priority Data
Oct. 23, 2020 (CA) 3097280

(51) Int. Cl. F16L 3/10

(52) U.S. Cl. CPC F16L 3/1016

(57) ABSTRACT

A clamp includes a polymer having metal particles dispersed therein. The metal particles can be made of aluminum. In one aspect, the clamp contains a metal core for rigidity. One use of the clamp is within aircraft for holding fuel line tubing in place.

### CROSS-REFERENCES TO RELATED APPLICATIONS

This application claims the benefit of the Canadian patent application No. 3097280 filed on Oct. 23, 2020, the entire disclosures of which are incorporated herein by way of reference.

### FIELD OF THE INVENTION

In general, this disclosure relates to a clamp. More preferably, the type of clamp is a saddle clamp.

### BACKGROUND OF THE INVENTION

Clamps are typically used to secure articles to separate structures and some clamps can be cushioned and/or electrically grounded for certain applications. A typical type of clamp for tubing is a saddle clamp since it has separate upper and lower portions which can be applied on either side of the tubing.

One example application of a saddle clamp is within aircraft to secure fuel tubing within the fuel tank. Any such installation must be compliant with regulations which require an independent and reliable path in order to dissipate electrostatic charges. Typical regulation compliant saddle clamps use a grounded cushion in combination with a Polyetheretherketone (PEEK) bracket as a means to dissipate electrostatic charges on aircraft fuel tanks. Such a clamp is described, for example, in U.S. Pat. No. 8,748,748 and shown in FIG. 1. The saddle clamp has metallic inner parts 10 within an elastomer cushion 12. The metallic inner parts 10 contact the tubing while holding the tubing within the elastomer cushion 12 and are electrically connected to the metallic end portions 14.

A typical installation of such a saddle clamp is provided in FIG. 2. A

PEEK bracket 20 is installed on a rib 22 of the aircraft onto which the saddle clamp 24 is connected. Any electrostatic charges are discharged from the tubing 26 to the saddle clamp 24 and from the saddle clamp 24 to the PEEK bracket 20. Finally, the electrostatic charges are discharged into the rib 22.

Aircraft can undergo high vibration during operation. Such high vibration can cause damage to the tubing due to friction against the metallic parts of the clamp. As a result, tubing will have to be replaced due to damage caused by friction.

### SUMMARY OF THE INVENTION

There is provided a clamp comprising a polymer having metal particles dispersed therein. The metal particles can be made of aluminum. In one aspect, the clamp contains a metal core for rigidity. The clamp can be formed as a saddle clamp and used within aircraft for holding fuel line tubing in place.

### BRIEF DESCRIPTION OF THE DRAWINGS

The invention will be further understood from the following description with reference to the attached drawings.

FIG. 1 illustrates a prior art saddle clamp.

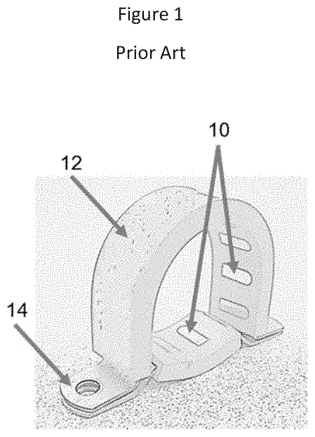

FIG. 2 illustrates a prior art saddle clamp attached to a PEEK bracket on a rib of an aircraft.

FIG. 3 illustrates a sample embodiment of a saddle clamp.

FIG. 4 illustrates a schematic of the components of the saddle clamp.

### DETAILED DESCRIPTION OF THE PREFERRED EMBODIMENTS

The exemplary embodiments of the present disclosure are described and illustrated below to encompass a clamp, with specific form of a saddle clamp for example purposes only. Of course, it will be apparent to those of ordinary skill in the art that the embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure.

In one example embodiment there is provided a clamp which contains monodispersed spherical particles of aluminum distributed into a thermoplastic. In an example embodiment, the size of the aluminum particles is preferably between 100 μm to 150 μm in order to permit discharge of electrostatic charges. Preferably, the filler packing factor, or atomic packing factor, is between 0.65 and 0.75 since such a size provides ease in manufacture. In this example, the size of the particles and filler packing factor are selected to exceed the percolation threshold in order to satisfy proper dissipation of electrostatic charges.

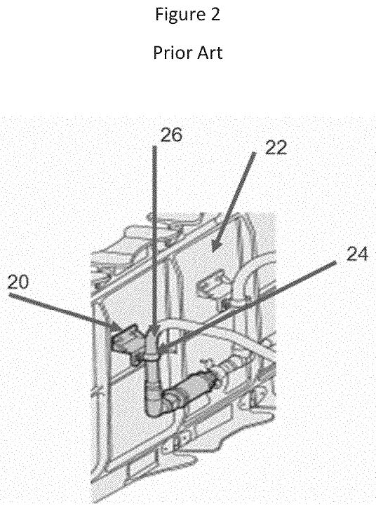

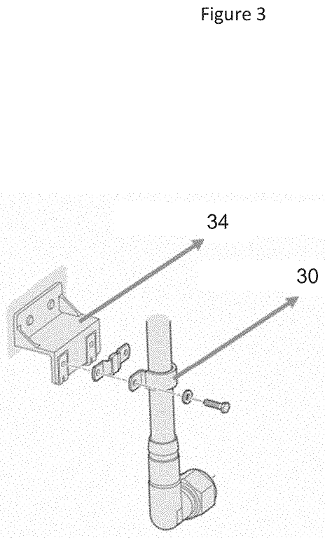

An example conductive saddle clamp is shown in FIG. 3. The shape of the saddle clamp remains the same as previously known saddle clamp shapes for consistency with existing tubing requirements. In this example embodiment, the conductive saddle clamp 30 can be attached to a high resistance bracket 34. The saddle clamp 30 can be used in combination with any desired bracket, such as the current PEEK bracket 20 shown in FIG. 2. When the conductive saddle clamp is attached to the bracket and the bracket is affixed to an aircraft rib, electrostatic charges are discharged from the tubing to the monodispersed spherical particles of the conductive saddle clamp to the bracket and into the rib.

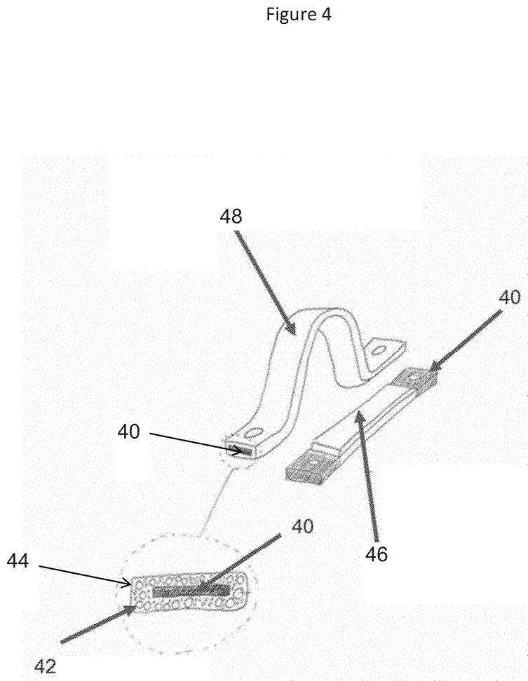

As shown in FIG. 4, in one example embodiment, the clamp is composed with a lower portion 46 and an upper portion 48. Both portions can contain a metallic core 40 to ensure rigidity of the clamp for solid restraining of the tubing. In this example embodiment, the material surrounding the metallic core contains aluminum particles 42 dispersed in polymer 44. The polymer 44 could be any suitable polymer, such as nitrile butadiene or ethylene propylene. It is understood that the metallic core 40 can be provided only in a portion of the saddle clamp, such as the lower portion 46 or the upper portion 48, or alternatively, the metallic core could be provided throughout the entire clamp. Similarly, the aluminum particles 42 can be provided only in a portion of the saddle clamp, such as the lower portion 46 or the upper portion 48, or alternatively, the particles could be provided throughout the entire clamp.

The formation of a saddle clamp, as described herein, when used in an aircraft results in a reduction of any friction between the aircraft fuel tubing and the saddle clamp, thereby reducing damage to the tubing caused by vibration of the aircraft. Furthermore, the saddle clamp is consistent with the shape of previous saddle clamps and can be used within any typical arrangement requiring such a saddle clamp without modification of the surrounding structure.

It will be appreciated by one skilled in the art that variants can exist in the above-described arrangements and applications. For example, the type of polymer or the type of dispersed metal could be varied. Similarly, although the invention has been described with respect to an example embodiment of a saddle clamp, the invention can be applied to other types of clamps. In addition, the shape of the saddle clamp can vary, along with the formation thereof For example, the clamp could be formed as a single integral piece, rather than two pieces. As another variation, the metallic core could be formed in only a portion of the clamp. The size of particles could vary, provided the intended result of dispersion of electrostatic charges remains.

Following from the above description, it should be apparent to those of ordinary skill in the art that, while the methods and apparatuses herein described constitute exemplary embodiments of the present invention, the invention described herein is not limited to any precise embodiment and that changes may be made to such embodiments without departing from the scope of the invention as defined by the claims. Consequently, the scope of the claims should not be limited by the preferred embodiments set forth in the examples but should be given the broadest interpretation consistent with the description as a whole. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A clamp, comprising:
a polymer having metal particles dispersed therein.

2. The clamp of claim 1, wherein the polymer is nitrile butadiene.

3. The clamp of claim 1, wherein the polymer is ethylene propylene.

4. The clamp of claim 1, wherein the metal particles are aluminum.

5. The clamp of claim 1 wherein a size of the metal particles is between 100 μm to 150 μm.

6. The clamp of claim 1, wherein a filler packing factor of the metal particles in the polymer is between 0.65 and 0.75.

7. The clamp of claim 1, wherein the clamp has an upper portion and a separate lower portion.

8. The clamp of claim 1, further comprising a metallic core within the polymer.

9. The clamp of claim 7, further comprising a metallic core within the polymer, wherein the metallic core is located within one of the upper portion, the lower portion or both the upper and lower potions.
